(19) United States
(12) Patent Application Publication
(10) Pub. No.: US 2026/0103364 A1
(43) Pub. Date: Apr. 16, 2026

(54) FRICTION LOCK BAR JACK FOR CONSTRUCTION

(71) Applicant: Robert N. Poole, Prescott, AZ (US)

(72) Inventor: Robert N. Poole, Prescott, AZ (US)

(21) Appl. No.: 19/353,491

(22) Filed: Oct. 8, 2025

Related U.S. Application Data
(60) Provisional application No. 63/705,586, filed on Oct. 10, 2024.

(51) Int. Cl. B66F 1/02

(52) U.S. Cl. CPC B66F 1/02

(57) ABSTRACT

A friction lock bar jack for lifting items including an elongated bar having a distal end and a proximal end, a lifting mechanism reciprocally slidably carried by the elongated bar and including a toggle mounting body, an actuating lever pivotally coupled to the toggle mounting body and movable between a neutral position and a drive position and a toggle mechanism to frictional engage the elongated bar and move the toggle mounting body incrementally toward the distal end with the actuating lever in the drive position, and freely movable along the elongated bar with the actuating lever in the neutral position. A locking assembly is received about the elongated bar and carried by the lifting mechanism to selectively prevent movement of the lifting mechanism toward the proximal end and allow movement toward the distal end.

### CROSS-REFERENCE TO RELATED APPLICATION

This application claims the benefit of U.S. Provisional Application No. 63/705,586, filed 10 Oct. 2024.

### FILED OF THE INVENTION

This invention relates to jacks for lifting items and more specifically to jacks for use in construction.

### BACKGROUND OF THE INVENTION

In the field of lifting jacks, most jacks are intended to lift heavy objects with minimal effort, providing the mechanical advantage needed to lift and hold large loads. The most common applications are in the automotive industry for vehicle maintenance such as wheel replacement, engine replacement and the like. Conventional lifting jacks are either mechanical, such as a scissor jack or a screw jack, or hydraulic jacks. In either case, the jack is very robust to lift and hold those objects. While these lifting jacks are useful as intended, they can be heavy and cumbersome to use.

In building construction and remodeling, as well as other industries, the lifting and holding in position of lighter objects is often desired. As an example, cabinetry is typically installed by holding the cabinet up on a wall while it is secured. This generally requires multiple installers. A device to lift and hold such an item in position is desirable. Unfortunately, existing lifting jacks are much too cumbersome and imprecise to use in this manner.

It would be highly advantageous, therefore, to remedy the foregoing and other deficiencies inherent in the prior art.

An object of the invention is to provide a friction lock jack for lifting light and unwieldy objects.

### SUMMARY OF THE INVENTION

Briefly, to achieve the desired objects and advantages of the instant invention, provided is a friction lock bar jack for lifting items. The friction lock bar clamp includes an elongated bar having a proximal end and a distal end, a base coupled to the distal end, and a lifting mechanism reciprocally slidably carried by the elongated bar. The lifting mechanism includes a toggle mounting body having a channel formed therethrough in receipt of the elongated bar, an actuating lever pivotally coupled to the toggle mounting body and movable between a neutral position and a drive position and a toggle mechanism including three pivotally linked elements attached between the actuating lever and the elongated bar, wherein the three pivotally linked elements interact to frictional engage the elongated bar with the actuating lever in the drive position, moving the toggle mounting body an increment toward the distal end of the elongated bar, and the three pivotally linked elements freely movable along the elongated bar with the actuating lever in the neutral position. A locking assembly is received about the elongated bar and is carried by the lifting mechanism to selectively prevent movement of the lifting mechanism toward the proximal end and allow movement toward the distal end. A support member is coupled to the toggle mounting body.

In a specific aspect, the toggle mechanism includes a locking element carried by the elongated bar for reciprocal and canting movement, an element pivotally coupled to the actuating lever, and a cam element pivotally coupled to the element and pivotally coupled to the locking element. The cam element being movable between a first condition permitting the locking element to reciprocate along the guide and a second condition bearing against the guide and canting the locking element into frictional engagement with the elongated bar and driving the element and thus the lift mechanism incrementally toward the distal end of elongated bar.

### BRIEF DESCRIPTION OF THE DRAWINGS

Specific objects and advantages of the invention will become readily apparent to those skilled in the art from the following detailed description of a preferred embodiment thereof, taken in conjunction with the drawings in which:

FIG. 1 is a perspective view of a bar jack in accordance with the present invention;

FIG. 2 is an exploded view of the bar jack of FIG. 1;

FIG. 3 is a side view of the bar jack of FIG. 1 with the lift mechanism being moved upwardly;

FIG. 4 is a side view of the bar jack of FIG. 1 with the lift mechanism moving downwardly;

FIG. 5 is an enlarge portion of FIG. 4 illustrating a locking plate according to the present invention;

FIG. 6 is a side view illustrating a toggle mechanism of the bar jack, in the neutral position;

FIG. 7 is a side view illustrating a toggle mechanism of the bar jack, in the locked and extended position;

FIG. 8 is a side view illustrating the bar jack tilted at different angles;

FIG. 9 is a side view illustrating the bar jack with an added adjustable extension bar;

FIG. 10 is a perspective view of another embodiment of a bar jack in accordance with the present invention;

FIG. 11 is an exploded view of the bar jack of FIG. 10;

FIG. 12 is a cut-away side view of the bar jack of FIG. 10;

FIG. 13 is a side view of the bar jack of FIG. 10 with the toggle mounting body removed to illustrate the inner elements; and

FIG. 14 is a side view of the bar jack of FIG. 13 with the toggle mounting body removed and the locking assembly partially exploded.

### DETAILED DESCRIPTION OF THE PREFERRED EMBODIMENTS

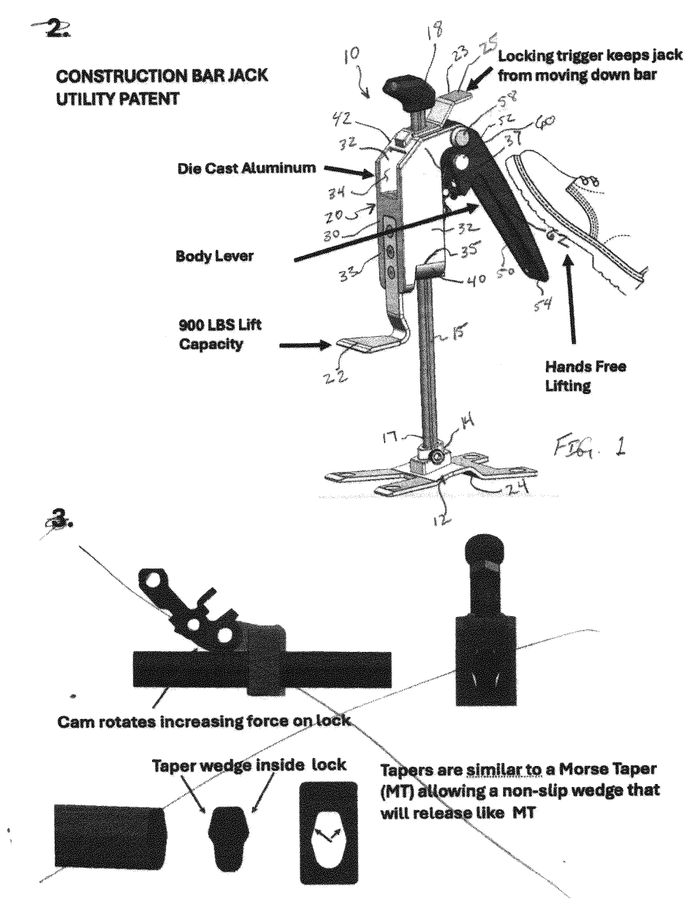

Turning now to the drawings in which like reference characters indicate corresponding elements throughout the several views, attention is directed to FIG. 1 which illustrates a friction lock bar jack generally designated 10, in accordance with the present invention. Bar jack 10 includes a base 12 having a bar socket 14, an elongated bar 15 with a proximal end 17 received by bar socket 14, a distal end 18, and a lifting mechanism 20 reciprocally slidably movable along elongated bar 15. A support member 22 is attached to lifting mechanism 20 for receipt of an item to be lifted and supported thereby. A locking plate 23 of a locking assembly 21 is received about elongated bar 15 and carried by lifting mechanism 20 to selectively prevent movement of lifting mechanism 20 toward proximal end 17 and allow movement toward distal end 18. Base 12 includes a bottom surface 24 to rest on a work surface and to support elongated bar 15, lifting mechanism 20 and any item supported by support member 22 above that surface. As an example, during installation of kitchen cupboard uppers, the work surface upon which base 12 rests can be the lower counter or cupboards, with sufficient protection for the counter such as a board cover and the like. The uppers are then lifted into position for fastening to the wall by bar jack 10.

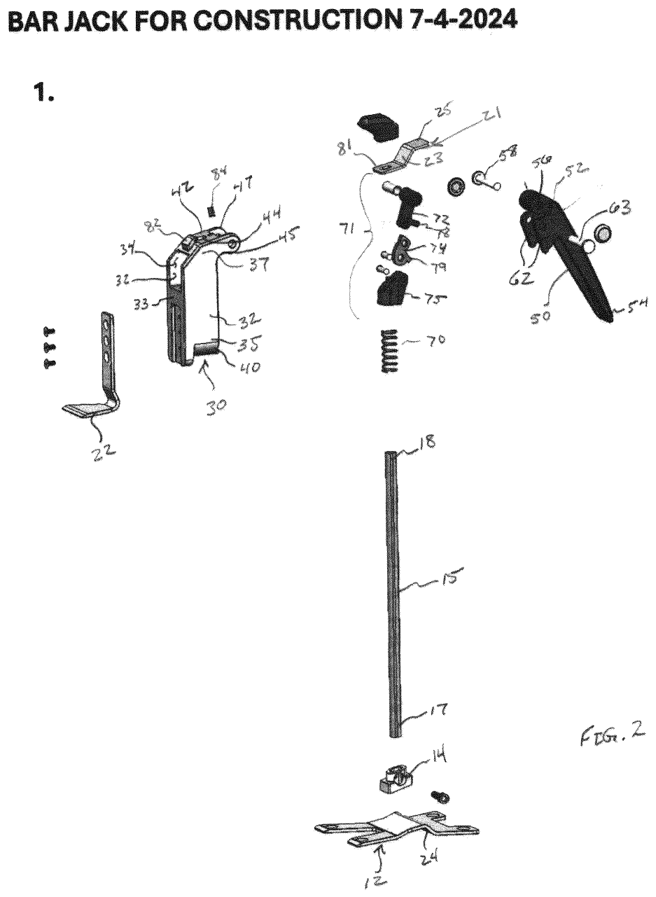

With additional reference to FIG. 2, lifting mechanism 20 includes a toggle mounting body 30 formed of a pair of side walls 32 extending in parallel spaced apart relationship from a front plate 33 to essentially form an elongated channel 34 therebetween from a bottom end 35 to a top end 37. A bottom wall 40 extends between sidewalls 32 at bottom end 35 and a top wall 42 extends between sidewalls 32 at top end 37. Apertures 43 and 44 are formed therethrough bottom wall 40 and top wall 42, respectively, and are in communication with channel 34 and sized to receive elongated bar 15 therethrough. Sides walls 32 include bracket members 45 and 47 extending from top end 37, rearwardly away from front plate 33. An elongated actuating lever 50 includes a proximal end 52 pivotally coupled to toggle mounting body 30 proximate top end 37 and a distal end 54 extending downwardly from proximal end 52 and away from face plate 33. Proximal end 52 is pivotally coupled to top end 37 at a pivot point 56 by a pin 58 journaled through apertures in bracket members 45 and 47 and through an aperture at pivot point 56. Elongated actuating lever 50 is movable between a raised neutral position and a lowered drive position. The progression between these positions will be described presently. Actuating lever 50 further includes a pivot point 60 positioned below pivot point 56 extending between two parallel projections 62 extending downwardly and toward front plate 33 from actuating lever 50 toward proximal end 52 and below pivot point 56. The two parallel projections 62 are spaced apart at pivot point 60 to form a mounting yoke that is positioned on both sides of a link, with a pivot pin 63 extending through both parallel projections 62 and the link, which will be described presently.

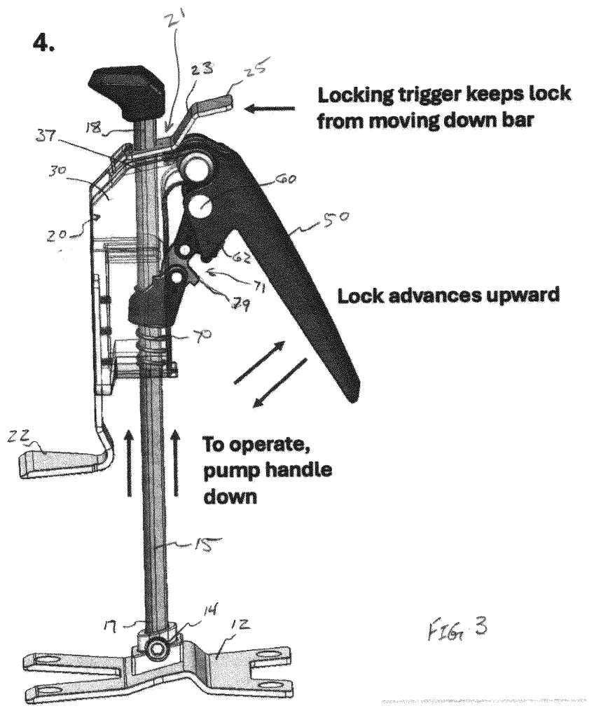

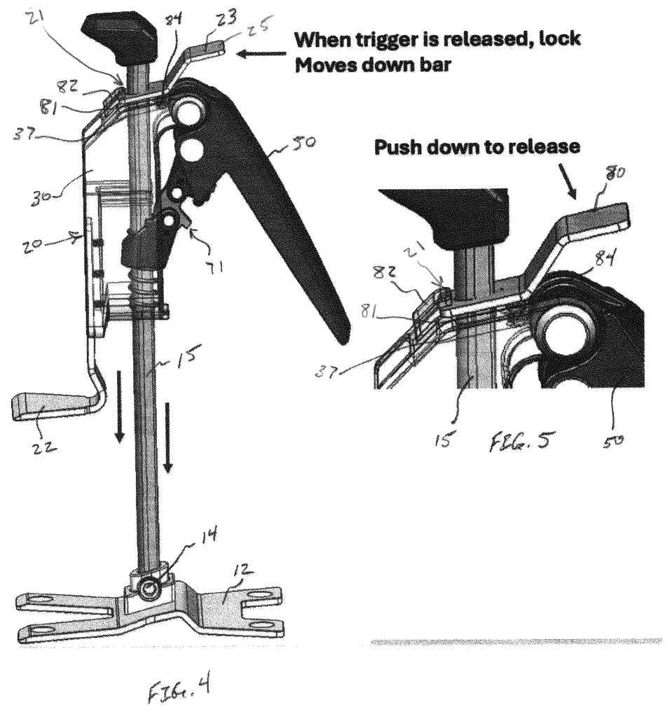

With continued reference to FIG. 2 and additional reference to FIG. 3, elongated bar 15 has a compression spring 70 axially disposed around a portion thereof and is positioned in elongated channel 34 of toggle mounting body 30. A toggle mechanism 71 generally includes three pivotally linked elements designated element 72, cam element 74, and locking element 75. Element 72 has an elongated body with the upper end pivotally attached between spaced two parallel projections 62 of actuating lever 50 at pivot point 60. The lower end of element 72 is bifurcated and the upper end of cam element 74 is pivotally mounted in the bifurcation. Also, the lower end of element 72 has an extending boss 78. The lower end of cam element 74 is pivotally engaged in a bifurcated upper end of locking element 75 and locking element 75 is slideably engaged over bar 15 and butts against a top end of compression spring 70. The lower end of spring 70 butts against an inner surface of bottom wall 40 of body 30. The rearward side of cam element 74 defines a pressure surface 79 positioned to engage boss 78 and restrict pivotal movement of toggle mechanism 70.

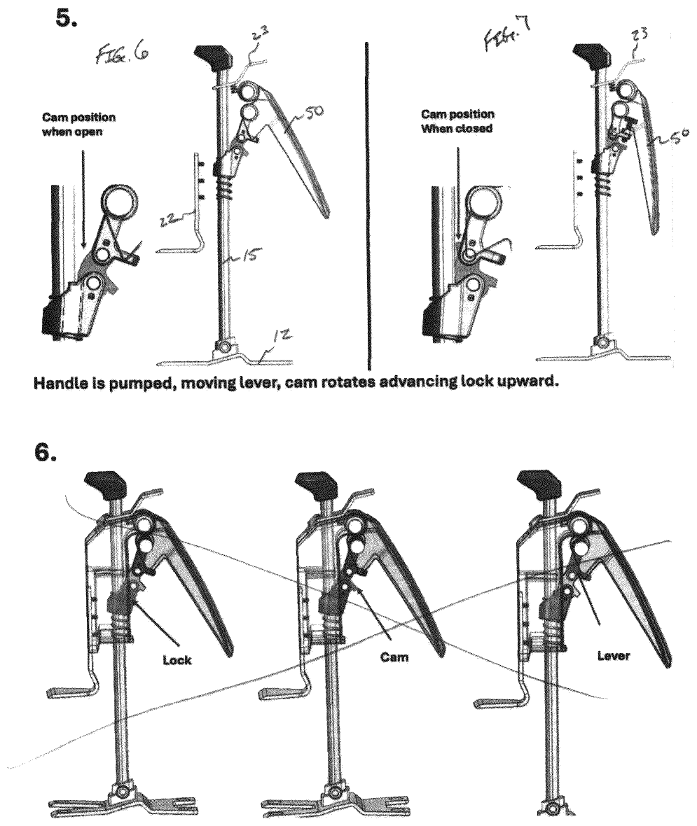

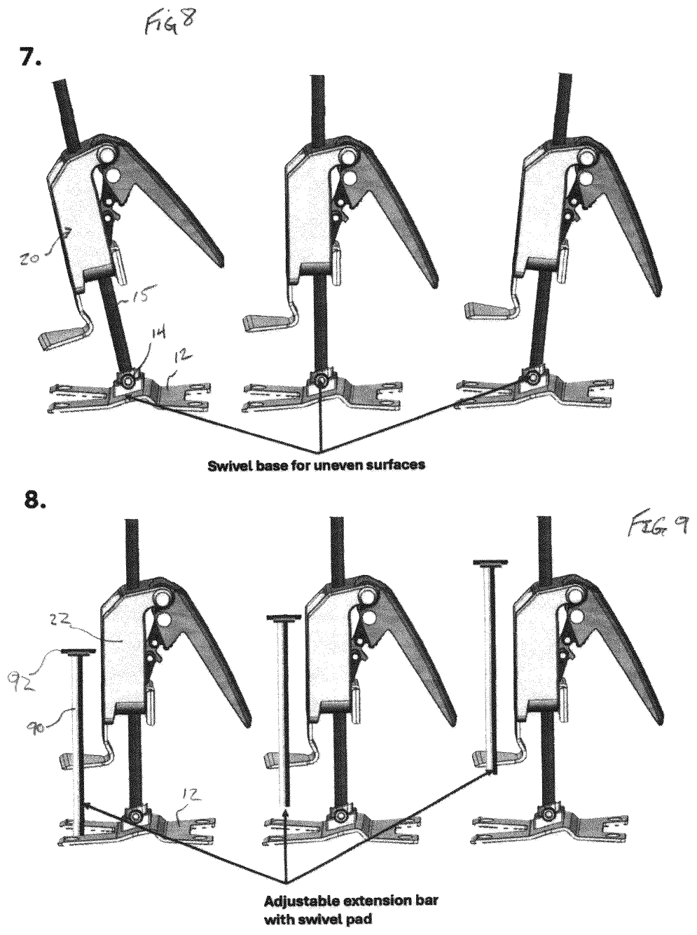

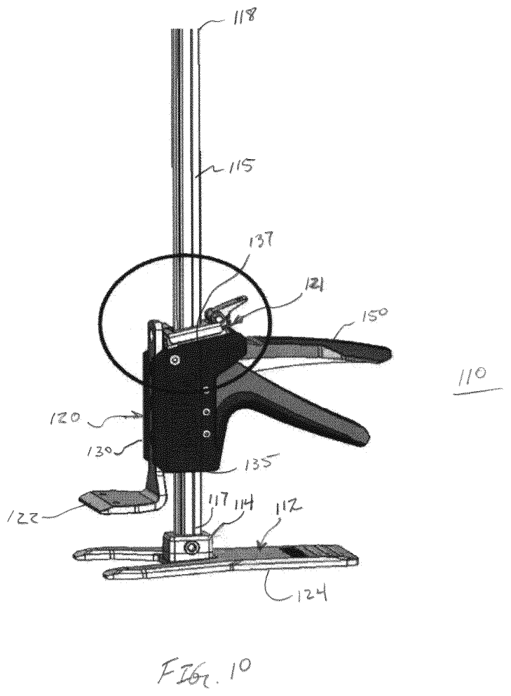

With continued reference to FIG. 3 and additional reference to FIGS. 6 and 7, actuating lever 50 is movable between neutral position (FIGS. 3 and 6) and a drive position (FIG. 7), to raise lift member 22 along with lift mechanism 20 along bar 15. In the neutral position of actuating lever 50, locking element 75 is positioned for sliding movement in relation to bar 15. When lever 50 is moved toward the drive position, first, locking element 75 is tilted (canted) relative bar 15 and thus frictionally engages bar 15, then cam element 74 pivots extending element 72 away from locking element 75 and driving lift mechanism 20 incrementally upwardly along bar 15. Lift member 22 is moved upwardly with the upward movement of lift mechanism 20 along bar 15. Multiple reciprocal movements (pumping) of lever 50 results in continued upward movement of lift mechanism 20.

After each incremental lift movement, locking plate 23 of locking assembly 21 engages elongated bar 15, holding lift mechanism 20 in position. Locking plate 23 is carried by top end 37 of body 30. With momentary reference to FIG. 5, locking plate 23 has an end 81 pivotally fixed to top end 37 of body 30 by a tab 82, and movable between an engaged position (frictionally engaging bar 15) and a released position (disengaged from bar 15). Locking assembly 21 further includes a spring 84 biasing locking plate 23 into frictional engagement with bar 15, preventing downward movement of body 30 while allowing upward movement thereof. In this manner, each time actuating lever 50 is moved from the neutral position to the drive position, toggle mechanism 71 is moved incrementally upwardly along bar 15, and when actuating lever 50 is moved from the drive position and the neutral position, bar 15 is held in position by the locking plate 23 of locking assembly 21. Locking assembly 21 can be released by manually depressing a trigger portion 25 of locking plate 23. Trigger portion 25, in this embodiment, is a portion of locking plate 23 extending outwardly in relation to elongated bar 15 opposite tab 82. When trigger portion 25 is depressed, locking plate 23 is moved downwardly, tilting against the bias of spring 84 to the release position, releasing bar 15. Locking assembly 21 can employ multiple locking plates below locking plate 23 to strengthen the structure. Additionally, while locking plate 23 is positioned at top end 37 of toggle mounting body 30 in this preferred embodiment, it can be positioned proximate bottom 35 of body 30. By depressing trigger 25 and locking plate 23 with actuating lever 50 in the neutral position, lift mechanism 20 will slide toward proximal end 17 of bar 15. A slowed lowering of lift mechanism 20 can be achieved by incrementally lowering lift mechanism 20. Incremental lower of lift mechanism 20 occurs when locking plate 23 is momentarily moved to the release position, followed by actuating lever 50 being moved to the neutral position. Upon each repetition of these steps, lift mechanism 20 will be incrementally lowered, such as by ¼ inch for example. In this manner, lift mechanism 20 can be incrementally raised, lifting heavy weights, incrementally lowered as needed, and fully retracted, preferably when no weight is carried by lift member 22.

FIG. 7 illustrates how the angle of bar 15 can be adjusted relative base 12 by tilting bar socket 14 to a desired angle. This, in turn, tilts lift mechanism 20 to a desired angle.

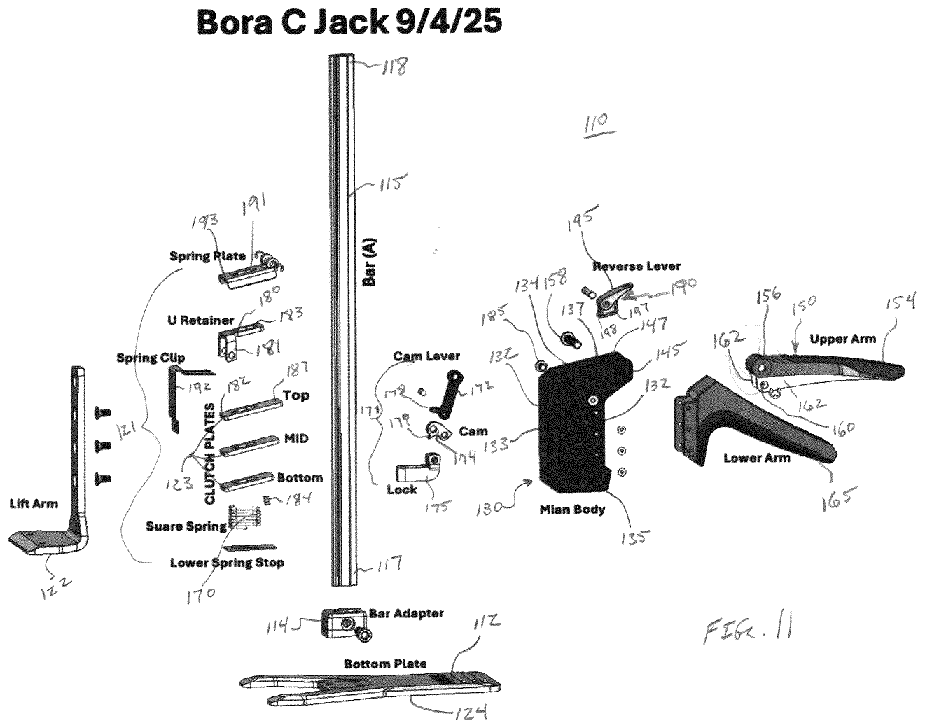

Referring to FIG. 9, an adjustable extension bar 90 terminating in a swivel pad 92 can be adjustably coupled to lift member 22. Bar 90 can be raised and lowered relative lift member 22 as desired.

Turning now to FIG. 10, another embodiment of a bar jack, generally designated 110, is illustrated in accordance with the present invention. Bar jack 110 includes a base 112 having a bar socket 114, an elongated bar 115 with a proximal end 117 received by bar socket 114, a distal end 118, and a lifting mechanism 120 reciprocally slidably movable along elongated bar 115. A support member 122 is attached to lifting mechanism 120 for receipt of an item to be lifted and supported thereby. A locking assembly 121 is received about elongated bar 115 and carried by lifting mechanism 120 to selectively prevent movement of lifting mechanism 120 toward proximal end 117 and allow movement toward distal end 118. Base 112 includes a bottom surface 124 to rest on a work surface and to support elongated bar 115, lifting mechanism 120 and any item supported by support member 122 above that surface. As an example, during installation of kitchen cupboard uppers, the work surface upon which base 112 rests can be the lower counter or cupboards, with sufficient protection for the counter such as a board cover and the like. The uppers are then lifted into position for fastening to the wall by bar jack 110.

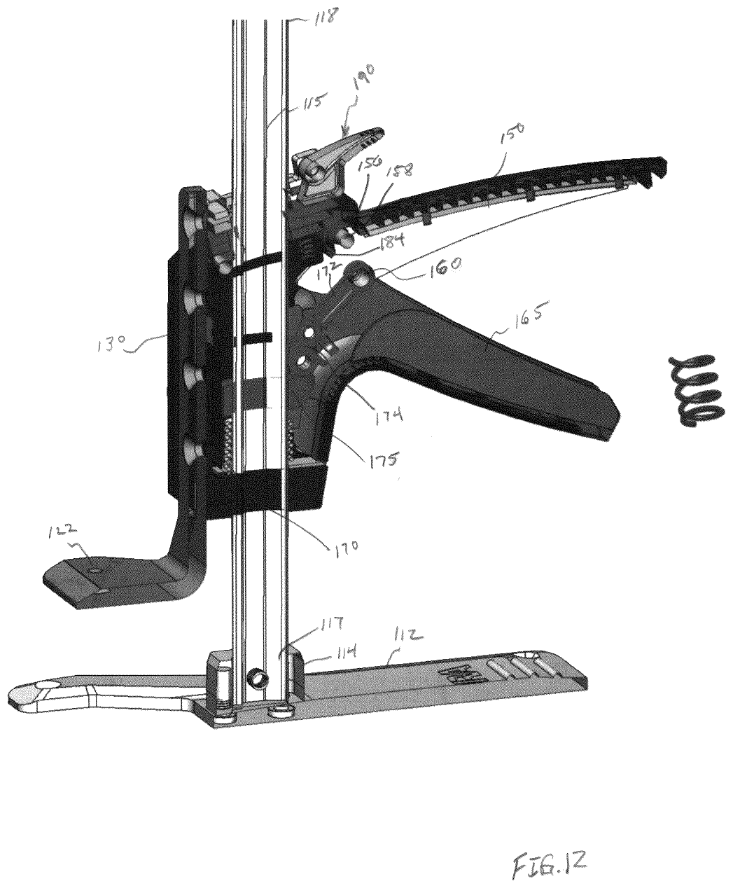

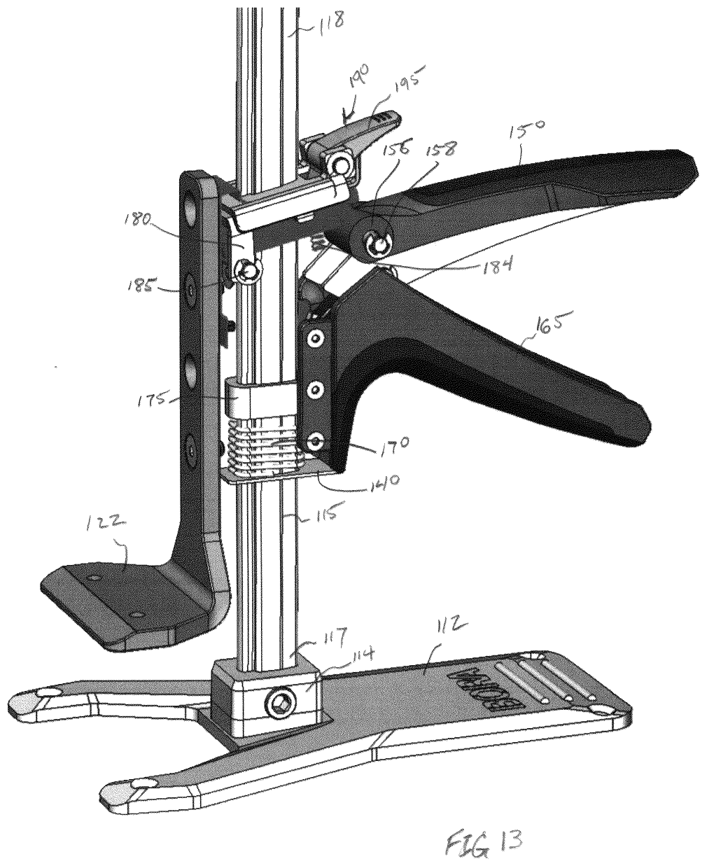

With additional reference to FIG. 11, lifting mechanism 120 includes a toggle mounting body 130 formed of a pair of side walls 132 extending in parallel spaced apart relationship from a front plate 133 to essentially form an elongated channel 134 therebetween from a bottom end 135 to a top end 137 to receive elongated bar 115 therethrough. A lower spring stop 140 is supported by toggle mounting body 130 and extends between sidewalls 132 at bottom end 135. Sides walls 132 include bracket members 145 and 147 extending from top end 137, rearwardly away from front plate 133. An elongated actuating lever 150 includes a proximal end 152 pivotally coupled to toggle mounting body 130 proximate top end 137 and a distal end 154 extending away from proximal end 152 and away from face plate 133. Proximal end 152 is pivotally coupled to top end 137 at a pivot point 156 (FIG. 12) by a pin 158 journaled through apertures in bracket members 145 and 147 and through an aperture at pivot point 156. Elongated actuating lever 150 is movable between a raised neutral position and a lowered drive position. The progression between these positions will be described presently. Actuating lever 150 further includes a pivot point 160 positioned below pivot point 156 extending between two parallel projections 162 extending downwardly and toward front plate 133 from actuating lever 150 toward proximal end 152 and below pivot point 156. The two parallel projections 162 are spaced apart at pivot point 160 to form a mounting yoke that is positioned on both sides of a link, with a pivot pin extending through both parallel projections 162 and the link, which will be described presently. A lower handle 165 is fixedly coupled to toggle mounting body 130 and extends therefrom below actuating lever 150. Lower handle 165 permits actuating lever 150 to be manipulated by a hand grasping both elements and squeezing.

With continued reference to FIG. 11 and additional reference to FIG. 12, elongated bar 115 has a compression spring 170 axially disposed around a portion thereof and is positioned in elongated channel 134 of toggle mounting body 130 and supported by lower spring stop 140. A toggle mechanism 171 generally includes three pivotally linked elements designated element 172, cam element 174, and locking element 175. Element 172 has an elongated body with the upper end pivotally attached between spaced two parallel projections 162 of actuating lever 150 at pivot point 160. The lower end of element 172 is bifurcated and the upper end of cam element 174 is pivotally mounted in the bifurcation. Also, the lower end of element 172 has an extending boss 178. The lower end of cam element 174 is pivotally engaged in a bifurcated upper end of locking element 175 and locking element 175 is slideably engaged over bar 115 and butts against a top end of compression spring 170. The lower end of spring 170 butts against lower spring stop 140 at bottom end 135. The rearward side of cam element 174 defines a pressure surface 179 positioned to engage boss 178 and restrict pivotal movement of toggle mechanism 170.

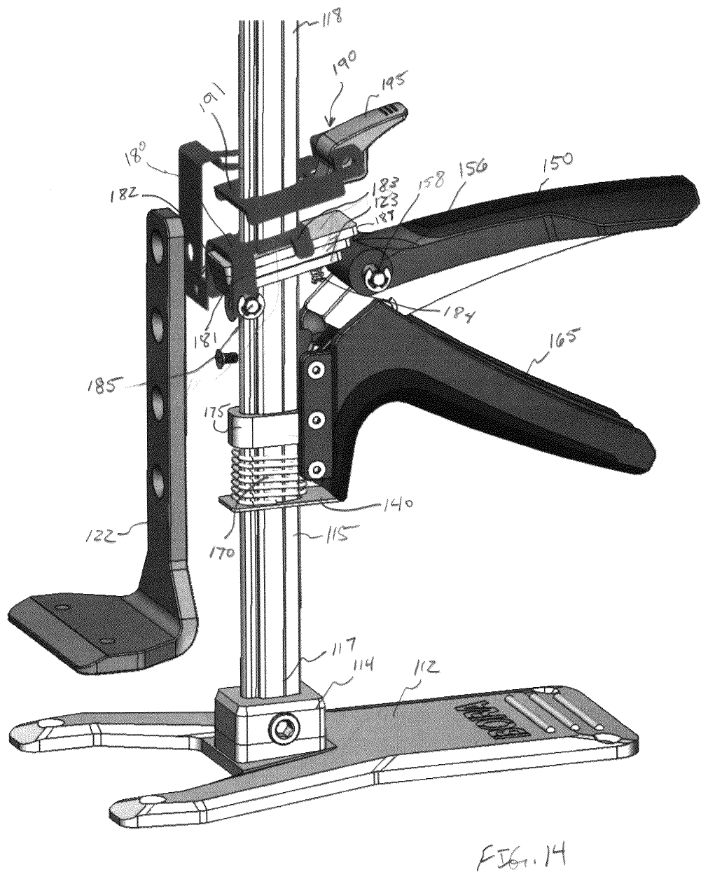

With continued reference to FIG. 12 and additional reference to FIGS. 13 and 14, actuating lever 150 is movable between neutral position (similar FIGS. 3 and 6) and a drive position (similar to FIG. 7), to raise lift member 122 along with lift mechanism 120 along bar 115. In the neutral position of actuating lever 150, locking element 175 is positioned for sliding movement in relation to bar 115. When lever 150 is moved toward the drive position, first locking element 175 is tilted (canted) relative bar 115 and thus frictionally engages bar 115, then cam element 174 pivots extending element 172 away from locking element 175 and driving lift mechanism 120 incrementally upwardly along bar 115. Lift member 122 is moved upwardly with the upward movement of lift mechanism 120 along bar 115. Multiple reciprocal movements (pumping) of lever 150 results in continued upward movement of lift mechanism 120.

After each incremental lift movement, locking assembly 121 engages elongated bar 115, holding lift mechanism 120 in position. Locking assembly 121, in this embodiment, includes a plurality of locking plates 123. While three locking plates 123 are employed in this embodiment, it will be understood that one or more can be used. Locking plates 123 are carried by top end 137 of body 130. With additional reference to FIG. 14, locking plates 123 are received in a stack about elongated bar 115 and held in position relative toggle mounting body 130 by a retainer 180. Retainer 180 has a downwardly directed U-shaped portion 181 which overlie pivot ends 182 of locking plated 123, and a sliding portion 183 slidably received about elongated bar 115. U-shaped portion 181 captures pivot ends 182 of locking plates 123 and is fixed to toggle mounting body 130 by a fastener 185. Thus, pivot ends 182 are held pivotally in position relative toggle mounting body 130. As toggle mounting body 130 is lifted or lowered, retainer 180 moves with it along elongated bar 115. Locking plates 123 have ends 187 opposite pivot ends 182 which are movable between an engaged position (frictionally engaging bar 115) and a released position (disengaged from bar 115). Locking assembly 121 further includes a spring 184 captured between ends 187 and toggle mounting body 130. Spring 184 biases ends 187 of locking plates 123 into frictional engagement with bar 115, preventing downward movement of body 130 while allowing upward movement thereof. In this manner, each time actuating lever 150 is moved from the neutral position to the drive position, toggle mechanism 171 is moved incrementally upwardly along bar 115, and when actuating lever 150 is moved from the drive position and the neutral position, bar 115 is held in position by the locking plates 123 of locking assembly 121.

Still referring to FIG. 11, and 12-14, a release mechanism 190 is employed to incrementally lower or fully lower lift mechanism 120. Release mechanism 190 includes a spring plate 191 slidably received about elongated bar 115 and overlying retainer 180 with associated locking plates 123. Spring plate 191 is biased downwardly by a spring clip 192 coupled to toggle mounting body 130, at an end 193 of spring plate 191. The downward bias of end 193 places spring plate 191 in an engaged position relative elongated bar 115. A reverse lever 195 is pivotally coupled to spring plate 191 and is movable between a neutral position, a release position, and a full release position. Upon manually depressing reverse lever 195 to the release position, ends 187 are moved downwardly, tilting locking plates 123 against the bias of spring 184 to the release position, releasing bar 15 a single increment. Each depression of reverse lever 195 lowers lift mechanism 120 a single increment as locking plates 123 move downwardly a distance determined by the depth of a tab 197 on reverse lever 195. This separates locking plates 123 from spring plate 191 and allows them to return to the engaged position preventing downward movement of lift mechanism 120. Once reverse lever 195 is released, spring plate 191 slides down bar 115 to again overlie the retainer 180 and locking plates 123 and the process can be repeated. Upon each repetition of these steps, lift mechanism 120 will be incrementally lowered, such as by ¼ inch for example. When reverse lever 195 is lifted upwardly to the full release position, a front tab 198 of reverse lever 195, ends 187 are moved downwardly, tilting locking plates 123 against the bias of spring 184 to the release position and held there to allow movement of lift mechanism fully downwardly on bar 115. By lifting reverse lever 195 to the full release position with actuating lever 150 in the neutral position, lift mechanism 120 will slide toward proximal end 117 of bar 115. It will be understood that reverse lever 195 can also be depressed fully, past the incremental position to fully lower lift mechanism 120. In this manner, lift mechanism 120 can be incrementally raised, lifting heavy weights, incrementally lowered as needed, and fully retracted, preferably when no weight is carried by lift member 122.

The present invention is described above with reference to illustrative embodiments. Those skilled in the art will recognize that changes and modifications may be made in the described embodiments without departing from the nature and scope of the present invention. Various changes and modifications to the embodiments herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A friction lock bar jack for lifting items, comprising:
an elongated bar having a proximal end and a distal end;
a lifting mechanism reciprocally slidably carried by the elongated bar, the lifting mechanism including:
a toggle mounting body having a channel formed therethrough in receipt of the elongated bar;
an actuating lever pivotally coupled to the toggle mounting body and movable between a neutral position and a drive position; and
a toggle mechanism including three pivotally linked elements attached between the actuating lever and the elongated bar, wherein the three pivotally linked elements interact to frictional engage the elongated bar with the actuating lever in the drive position, moving the toggle mounting body an increment toward the distal end of the elongated bar, and the three pivotally linked elements freely movable along the elongated bar with the actuating lever in the neutral position;
a locking assembly received about the elongated bar and carried by the lifting mechanism to selectively prevent movement of the lifting mechanism toward the proximal end and allow movement toward the distal end; and
a support member coupled to the toggle mounting body.

2. A friction lock bar jack as claimed in claim 1 wherein the three pivotally linked elements of the toggle mechanism include:
a locking element carried by the elongate bar for reciprocal and canting movement thereon;
an element pivotally coupled to the actuating lever; and
a cam element pivotally coupled to the element and pivotally coupled to the locking element, the cam element movable between a first condition permitting the locking element to reciprocate along the elongate bar and a second condition bearing against the elongate bar, canting the locking element into frictional engagement with the elongate bar and driving the element and thus the lift mechanism incrementally toward the distal end of elongated bar.

3. A friction lock bar jack as claimed in claim 1 wherein the locking assembly comprises at least one locking element carried by the toggle mounting body, the at least one locking element having an end fixed for pivotal movement to the toggle mounting body, the at least one locking element movable between an engaged position preventing movement of the lifting mechanism toward the proximal end of the elongated bar and a released position permitting movement of the lifting mechanism toward the proximal end of the elongated bar.

4. A friction lock bar jack as claimed in claim 3 wherein the locking assembly further includes a biasing element biasing the at least one locking plate into the engaged position.

5. A friction lock bar jack as claimed in claim 4 wherein the locking assembly further includes a release mechanism for moving the at least one locking element to the released position against the bias of the biasing element, permitting movement of the lifting mechanism toward the proximal end of the elongated bar.

6. A friction lock bar jack as claimed in claim 5 wherein the release mechanism includes a trigger extending from an end of the at least one locking element depression of which moves the at least one locking element to the release position.

7. A friction lock bar jack as claimed in claim 5 wherein the release mechanism includes a spring plate slidably received about the elongated bar and overlying the at least one locking plate, an end of the spring plate biased downwardly by a spring clip coupled to the toggle mounting body, and a reverse lever pivotally coupled to the spring plate and movable between a neutral position, a release position incrementally lowering the lifting mechanism, and a full release position allowing full lowering of the lifting mechanism.

8. A friction lock bar jack as claimed in claim 2 further comprising a biasing member captured between the locking element and a lower end of the toggle mounting body, biasing the locking element toward distal end of the elongated bar.

9. A friction lock bar jack as claimed in claim 1 further including a base coupled to the proximal end of the elongated bar.

10. A friction lock bar jack as claimed in claim 9 further including a bar socket adjustably coupling the proximal end of the elongated bar to the base.

11. A friction lock bar jack for lifting items, comprising:
an elongated bar having a proximal end and a distal end;
a base coupled to the distal end;
a lifting mechanism reciprocally slidably carried by the elongated bar, the lifting mechanism comprising:
a toggle mounting body having a channel formed therethrough in receipt of the elongated bar;
an actuating lever pivotally coupled to the toggle mounting body and movable between a neutral position and a drive position; and
a toggle mechanism including a locking element carried by the elongated bar for reciprocal and canting movement, an element pivotally coupled to the actuating lever, and a cam element pivotally coupled to the element and pivotally coupled to the locking element, the cam element movable between a first condition permitting the locking element to reciprocate along the guide and a second condition bearing against the guide and canting the locking element into frictional engagement with the elongated bar and driving the element and thus the lift mechanism incrementally toward the distal end of elongated bar;
a biasing member captured between the locking element and a lower end of the toggle mounting body, biasing the locking element toward distal end of the elongated bar;
a locking assembly received about the elongated bar and carried by the lifting mechanism to selectively prevent movement of the lifting mechanism toward the proximal end and allow movement toward the distal end; and
a support member coupled to the toggle mounting body.

12. A friction lock bar jack as claimed in claim 11 wherein the locking assembly comprises at least one locking element carried by the toggle mounting body, the at least one locking element having an end fixed for pivotal movement to the toggle mounting body, the at least one locking element movable between an engaged position preventing movement of the lifting mechanism toward the proximal end of the elongated bar and a released position permitting movement of the lifting mechanism toward the proximal end of the elongated bar.

13. A friction lock bar jack as claimed in claim 12 wherein the locking assembly further includes a biasing element biasing the at least one locking plate into the engaged position.

14. A friction lock bar jack as claimed in claim 13 wherein the locking assembly further includes a release mechanism for moving the at least one locking element to the released position against the bias of the biasing element, permitting movement of the lifting mechanism toward the proximal end of the elongated bar.

15. A friction lock bar jack as claimed in claim 14 wherein the release mechanism includes a trigger extending from an end of the at least one locking element, depression of which moves the at least one locking element to the release position.

16. A friction lock bar jack as claimed in claim 14 wherein the release mechanism includes a spring plate slidably received about the elongated bar and overlying the at least one locking plate, an end of the spring plate biased downwardly by a spring clip coupled to the toggle mounting body, and a reverse lever pivotally coupled to the spring plate and movable between a neutral position, a release position incrementally lowering the lifting mechanism, and a full release position allowing full lowering of the lifting mechanism.

17. A friction lock bar jack as claimed in claim 11 further comprising a biasing member captured between the locking element and a lower end of the toggle mounting body, biasing the locking element toward distal end of the elongated bar.
